(19) United States
(12) Patent Application Publication
(10) Pub. No.: US 2009/0247243 A1
(43) Pub. Date: Oct. 1, 2009

(54) HOUSING STRUCTURE OF HAND-HELD ELECTRONIC DEVICE

(75) Inventors: Shih-Hong Chen, Taipei (TW); Kun-Hsien Lee, Taipei (TW); Chia-Hsin Yu, Taipei (TW); Jen-Yung Chang, Taipei (TW); Yi-Te Lu, Taipei (TW)

Correspondence Address: QUINTERO LAW OFFICE, PC, 2210 MAIN STREET, SUITE 200, SANTA MONICA, CA, 90405, US

(73) Assignee: WISTRON NEWEB CORP., TAIPEI HSIEN (TW)

(21) Appl. No.: 12/328,724

(22) Filed: Dec. 4, 2008

(30) Foreign Application Priority Data
Mar. 31, 2008 (TW) TW97111640

(51) Int. Cl. H04M 1/00

(52) U.S. Cl. 455/575.1

(57) ABSTRACT

A housing structure of a hand-held electronic device is provided, including a first frame, a second frame connected to the first frame, and a transparent window. The first frame forms a slot and a flexible cantilever on a surface thereof, wherein the slot and the flexible cantilever are adjacent to each other, and the flexible cantilever is integrally formed with the first frame. The transparent window is also disposed on the surface and integrally formed with the first frame.

### CROSS REFERENCE TO RELATED APPLICATIONS

This Application claims priority of Taiwan Patent Application No. 97111640, filed on Mar. 31, 2008, the entirety of which is incorporated by reference herein.

### BACKGROUND OF THE INVENTION

1. Field of the Invention

The invention relates in general to a housing structure and in particular to a housing structure of a hand-held electronic device.

2. Description of the Related Art

Referring to FIG. 1, a housing structure of a conventional hand-held electronic device primarily includes a first frame 10 and a second frame 20 produced by plastic injection molding. As shown in FIG. 1, two holes 11 are formed on opposite sides of the first frame 10, and two button keys 30 are placed in the holes 11, respectively. Users can operate the electronic device or input data by pushing the button keys 30. Furthermore, a transparent plate 40 is disposed in a rectangular opening 12 in the middle of the first frame 10. Users can watch a display screen (not shown) on the electronic device through the transparent window 40.

### BRIEF SUMMARY OF INVENTION

The invention provides a housing structure of a hand-held electronic device including a first frame, a second frame connected to the first frame, and a transparent window. The first frame forms a slot and a flexible cantilever on a surface thereof, wherein the slot and the flexible cantilever are adjacent to each other, and the flexible cantilever is integrally formed with the first frame. The transparent window is also disposed on the surface and integrally formed with the first frame.

### BRIEF DESCRIPTION OF DRAWINGS

The invention can be more fully understood by reading the subsequent detailed description and examples with references made to the accompanying drawings, wherein:

FIG. 1 is an exploded diagram of a housing structure of a conventional hand-held electronic device;

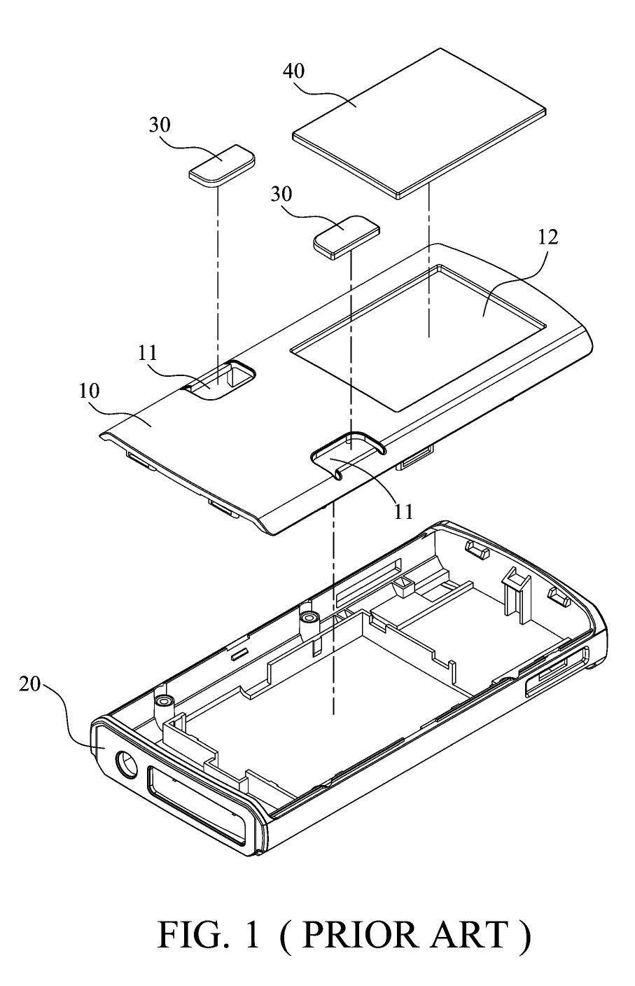

FIG. 2 is an exploded diagram of an embodiment of a housing structure of a hand-held electronic device according to the invention;

FIG. 3 is a top view of the housing structure of the hand-held electronic device in FIG. 2; and

FIG. 4 is a top view of another embodiment of a housing structure of a hand-held electronic device.

### DETAILED DESCRIPTION OF INVENTION

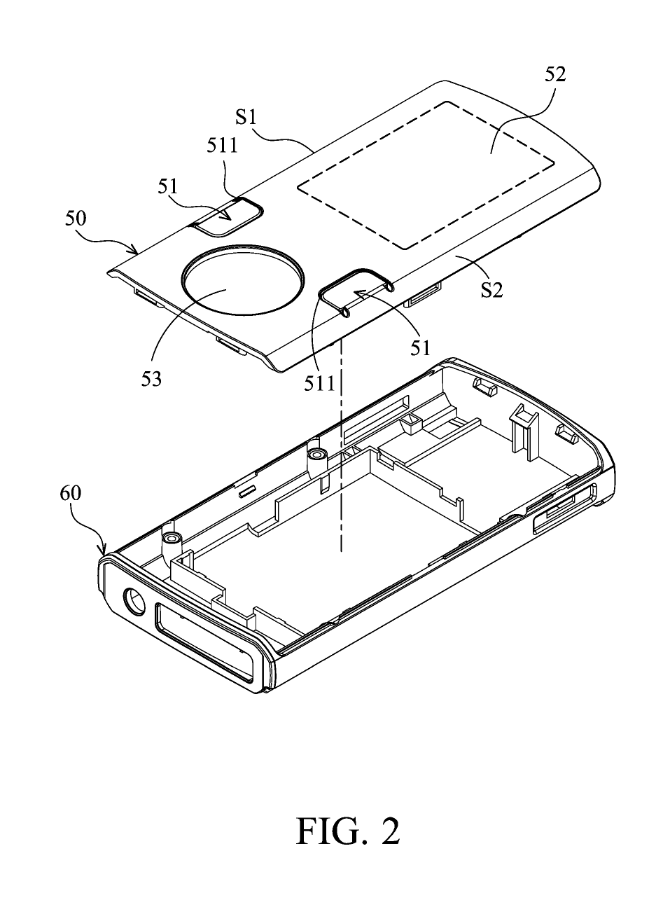

Referring to FIG. 2, an embodiment of a housing structure of a hand-held electronic device according to the invention, such as a mobile phone or a PDA device, primarily includes a first frame 50 and a second frame 60. The first and second frames 50 and 60 may be integrally formed in one piece by plastic injection molding, respectively. The first frame 50 comprises two U-shaped slots 511 near opposite edges S1 and S2 thereof, wherein the openings of the U-shaped slots 511 are substantially oriented toward the edges S1 and S2. A rectangular transparent window 52 is formed in the middle of the first frame 50. Users can watch a display screen (not shown) on the electronic device through the transparent window 52.

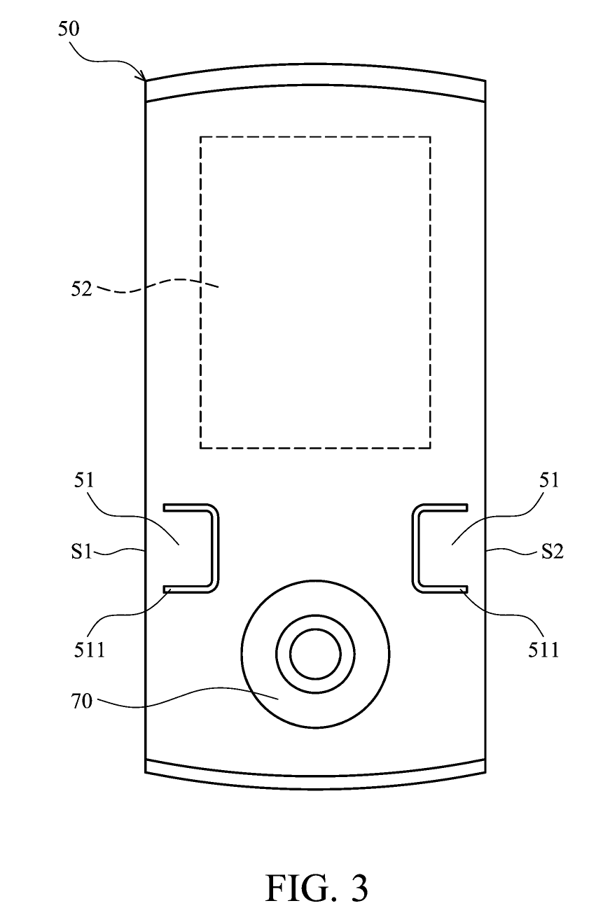

In this embodiment, the slots 511 and the transparent window 52 are formed on an upper surface of the first frame 50, wherein the transparent window 52 is integrally formed with the first frame 50 by an In Mold Decoration (IMD), In Mold Lamination (IML) or dual-material injection molding process. Referring to FIGS. 2 and 3, the first frame 50 further comprises a round through hole 53 below the transparent window 52 for receiving a control panel 70 (as shown in FIG. 3) or a roll wheel for manual control of the electronic device.

As shown in FIG. 2, two flexible cantilevers 51 are formed on the first frame 50, corresponding to the U-shaped slots 511. Here, the flexible cantilevers 51 are utilized as button keys for data input. In this embodiment, the transparent window 52 and the flexible cantilevers 51 are integrally formed with the first frame 50, requiring less number of parts than conventional hand-held electronic devices and improving integral and smooth appearance of the housing structure.

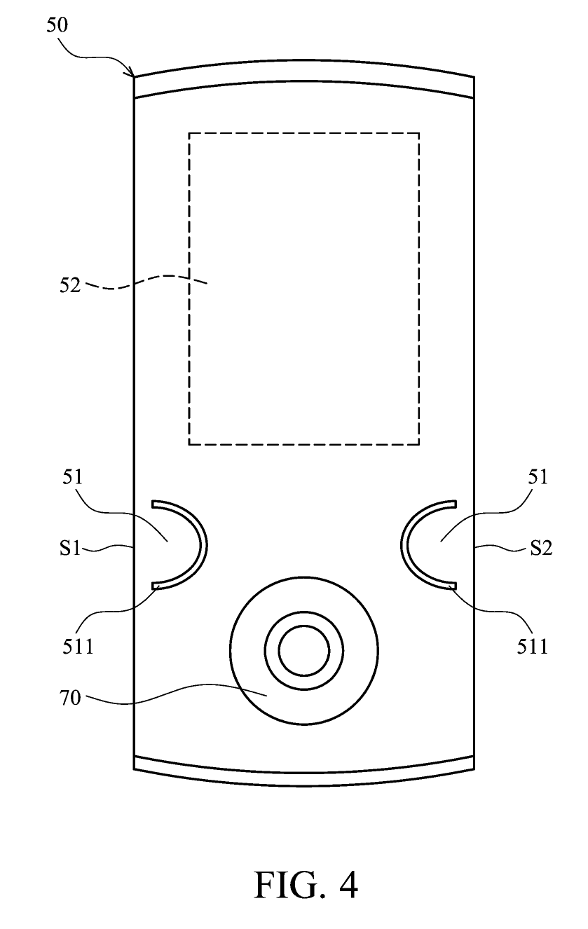

Referring to FIG. 4, another embodiment of the slots 511 are semicircular or crescent-shaped, wherein each of the flexible cantilevers 51 has a curved edge corresponding to the slots 511. When using the electronic device, user can press and slightly deform the flexible cantilevers 51 as a button key for data input. The flexible cantilevers 51 can return to the original position by its recovery force when the external force is released. Here, the flexible cantilevers 51 are integrally formed with the first frame 50, requiring less number of parts than conventional hand-held electronic devices. In some embodiments, the flexible cantilevers 51 may be disposed in the middle of the first frame 50 apart from the edges SI and S2, and the openings of the slots 511 may be oriented toward a top or bottom side of the first frame 50, rather than the left and right edges S1 and S2.

The invention provides a hand-held electronic device including a first frame having a flexible cantilever and a transparent window, wherein the flexible cantilever is utilized as a push button. An embodiment of the flexible cantilever and the transparent window are integrally formed with the first frame in one piece, thereby decreasing number of parts, reducing production costs and avoiding assembly defects.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A housing structure of a hand-held electronic device, comprising:
a first frame, comprising a slot and a flexible cantilever on a surface thereof, wherein the slot and the flexible cantilever are adjacent to each other, and the flexible cantilever is integrally formed with the first frame;
a transparent window, disposed on the surface and integrally formed with the first frame; and
a second frame connected to the first frame.

2. The housing structure of a hand-held electronic device as claimed in claim 1, wherein the slot is U-shaped, semicircular or crescent-shaped.

3. The housing structure of a hand-held electronic device as claimed in claim 2, wherein the slot is located near an edge of the first frame.

4. The housing structure of a hand-held electronic device as claimed in claim 2, wherein an opening of the slot is oriented toward an edge of the first frame.

5. The housing structure of a hand-held electronic device as claimed in claim 1, wherein the transparent window is integrally formed with the first frame by In Mold Decoration (IMD), In Mold Lamination (IML) or dual-material injection molding.

6. The housing structure of a hand-held electronic device as claimed in claim 5, wherein the transparent window is substantially rectangular.

7. The housing structure of a hand-held electronic device as claimed in claim 1, wherein the first frame further comprises a through hole for receiving a control panel or a roll wheel.

8. The housing structure of a hand-held electronic device as claimed in claim 1, wherein the first frame further comprises a plurality of slots and cantilevers corresponding thereto.

9. The electronic device as claimed in claim 1, wherein the first frame is integrally formed in one piece by plastic injection molding.

10. The electronic device as claimed in claim 1, wherein the second frame is integrally formed in one piece by plastic injection molding.
